(19) United States
(12) Patent Application Publication
(10) Pub. No.: US 2023/0405635 A1
(43) Pub. Date: Dec. 21, 2023

(54) ACOUSTIC AQUATIC TRACKING TRANSMITTER

(71) Applicant: BATTELLE MEMORIAL INSTITUTE, Richland, WA (US)

(72) Inventors: Zhiqun Deng, Richland, WA (US); Huidong Li, Richland, WA (US); Jun Lu, Richland, WA (US); Bingbin Wu, Richland, WA (US); Jayson J. Martinez, Kenneck, WA (US); Jie Xiao, Richland, WA (US)

(73) Assignee: BATTELLE MEMORIAL INSTITUTE, Richland, WA (US)

(21) Appl. No.: 18/332,544

(22) Filed: Jun. 9, 2023

Related U.S. Application Data
(60) Provisional application No. 63/350,511, filed on Jun. 9, 2022.

(51) Int. Cl. B06B 1/06; G01S 15/10; G01S 7/521

(52) U.S. Cl. CPC B06B 1/0611; B06B 1/0688; B06B 2201/56; G01S 7/521; G01S 15/102

(57) ABSTRACT

Aquatic tracking makes use of acoustics, rather than other signals that do not travel as well in water. Tracking devices are used to monitor species of fish and other aquatic animals to monitor how their populations and movements are in nature, and how or whether those populations and movements are affected by, for example, hydroelectric dams and other manmade structures and phenomena. Often, the trackers inserted in aquatic animals adversely affect the animals and can lead to mortality or changed behaviors. New solutions that decrease the size and weight of such tracking devices are disclosed herein, enabling better tracking of aquatic animals that is less likely to cause adverse effects to those populations.

### REFERENCE TO RELATED APPLICATIONS

This application claims the benefit of U.S. Provisional Application No. 63/350,511 filed on Jun. 9, 2022, the disclosure of which is incorporated herein by reference in its entirety.

### STATEMENT OF GOVERNMENT INTEREST

This invention was made with government support under Contract DE-AC0576RL01830 awarded by the U.S. Department of Energy. The government has certain rights in the invention.

### FIELD OF THE INVENTION

The present invention relates generally to acoustic tracking devices and systems. More particularly, the present invention relates to attachable acoustic transmission devices for detection and remote tracking of smaller or more sensitive hosts that can be injured or killed by conventional tracking tags.

### BACKGROUND

Acoustic transmission devices that process and track selected hosts are described in Applicant's previously granted patent, U.S. Pat. No. 10,739,434, the contents of which are incorporated herein by reference in their entirety. As described in that patent, acoustic telemetry involves acoustic devices (transmitters or tags) commonly used to monitor behavior of aquatic animals including fish.

Acoustic tags transmit a sound signal that transmits identification, location, and other information about a tagged fish to a receiver at a selected pulse rate interval (PRI), or “ping” rate. The receiver detects signals emitted by the acoustic tag and converts the sound signals into digital data. Post-processing software then processes the digital data and provides location information about the tag and thus the behavior of the fish when the receiver detects the sound signal. By identifying the signature of the acoustic signal a specific animal may be identified, which allows tracking the behavior of the host. Acoustic data may be used to estimate survival of fish through dams and other routes of passage, among other uses.

It has generally been desired to make injectable acoustic transmission devices that are suitable for use in tracking fish or other aquatic animals over time. Applicant's previously-granted patent, U.S. Pat. No. 10,033,469 describes such an injectable acoustic transmission device. The contents of U.S. Pat. No. 10,033,469 are also incorporated by reference in their entirety.

American shad (Alosa sapidissima) is an anadromous, migratory fish native to a large range across the East Coast of the US. In many rivers where shad are present, they must pass upstream and downstream of hydropower facilities multiple times to complete their life cycle. American shad are an economically valuable fishery, but their populations have been declining throughout their historic range. More than 100 US hydropower facilities with a total capacity of >4 GW will have expiring Federal Energy Regulatory Commission (FERC) licenses over the next 10 years and are within the native range of American shad. As a part of the FERC hydropower license process, fish passage and mitigation measures for American shad will be routinely and rigorously reviewed by federal agencies and stakeholders. Therefore, detailed movement information and behavioral characteristics of American shad, especially the juveniles, around hydropower facilities must be studied and understood to better protect them.

Implantable radio and acoustic telemetry tags have been the primary technologies for tracking aquatic animals. Compared to acoustic tags, implantation of radio tags is more invasive as those tags require an antenna exiting the body of the fish to function properly. Additionally, radio waves attenuate significantly in water and thus lead to a very limited transmission range underwater. Therefore, in the recent years, implantable acoustic tags became the preferred method to study fish's dam passage survival and other migration behavior metrics. To be able to study small and sensitive fish species, there have been continuous efforts to reduce the size of acoustic fish tags while maintaining reasonable service life. To date, the eel/lamprey acoustic transmitter (ELAT, hereinafter) from the Juvenile Salmon Acoustic Telemetry System (JSAT) is the world's smallest acoustic transmitter for fish tracking. Even with its small size, however, sensitive species such as the American Shad continue to exhibit high mortality rates when ELAT is implanted.

### SUMMARY

According to a first embodiment, an acoustic tracking device includes an acoustic transducer comprising a ferroelectric single crystal piezoelectric component. The acoustic tracking device further includes a microprocessor electronically coupled to the acoustic transducer to drive the acoustic transducer. The acoustic tracking device further includes an oscillator having a preset operating frequency, the oscillator electronically coupled to the microprocessor. A battery is electronically coupled to each of the microprocessor and the oscillator.

The acoustic transducer can include multiple ferroelectric single crystal piezoelectric components arranged in a stack, wherein the polling direction of a first one of the plurality of ferroelectric single crystal piezoelectric components is oriented opposite of the polling direction of an adjacent one of the ferroelectric single crystal piezoelectric components of the stack. The ferroelectric single crystal piezoelectric component can be shaped as a tube. The battery can be arranged within the tube formed by the ferroelectric single crystal piezoelectric. The preset operating frequency can be 417 kHz. A natural resonance frequency of the acoustic transducer can also be 417 kHz. The microprocessor can be configured to drive the acoustic transducer at the preset frequency. The microprocessor can be configured to calibrate a driving frequency of the acoustic transducer based upon a signal from the oscillator at the preset frequency. The acoustic tracking device can include a housing configured to hold the acoustic transducer, the microprocessor, the oscillator, and the battery within a form factor. The form factor can be substantially cylindrical, with a diameter of 2 mm or less and a length of 8 mm or less. The acoustic tracking device can have a weight of 57 mg or less.

According to another embodiment, an acoustic tracking device can include an acoustic transducer shaped substantially as a tube open at one end, a microprocessor electronically coupled to the acoustic transducer to drive the acoustic transducer, a battery arranged within the tube, and a cap arranged in the tube at the open end to hermetically seal the battery within the tube and the cap.

The acoustic tracking device can include a waterproof coating applied around the tube and the cap. The tube can include a ferroelectric single crystal piezoelectric with a hole drilled partially through it along the polling direction of the ferroelectric single crystal piezoelectric. The natural resonance frequency of the acoustic transducer can be 417 kHz, and the microprocessor can be configured to drive the acoustic transducer at a driving frequency of 417 kHz as well. The microprocessor can be configured to calibrate the driving frequency of the acoustic transducer based upon a signal from an oscillator.

According to another embodiment, a method is disclosed for forming a battery. The method includes connecting a wire to a foil element; inserting the foil and wire element into a piezoelectric tube; adhering the foil element to an inner electrode at one end of the piezoelectric tube; closing the one end of the piezoelectric tube at which the foil is adhered; applying a coating to the one end to seal the one end; placing a battery dry cell into the piezoelectric tube through a second end opposite the one end; adhering a closure disk to the second end; injecting an electrolyte into the center of the piezoelectric tube; and sealing the tube to the closure disk.

The piezoelectric tube can have a resonant frequency of 417 kHz.

According to another embodiment, a battery is disclosed that is formed according to the method described above.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an acoustic aquatic tracking device.

FIG. 2 is a perspective view of an acoustic aquatic tracking device according to one embodiment.

FIG. 3 is a single-transducer acoustic emitter usable in the acoustic aquatic tracking device of FIG. 2.

FIG. 4 is a single-transducer acoustic emitter usable in the acoustic aquatic tracking device of FIG. 2.

FIG. 5 depicts a method for forming a battery and piezoelectric transducer hybrid construct according to an embodiment.

FIG. 6 is a chart of acoustic emission uniformity of the construct of FIG. 5.

FIG. 7 shows the acoustic aquatic tracking device of FIG. 2 with axes defining directions, and FIGS. 8A-8F show uniformity of acoustic emissions along the axes of FIG. 7.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A recent laboratory tagging pilot study conducted by Pacific Northwest National Laboratory (PNNL) showed that, when implanted in juvenile American shad with a fork length of 60-80 mm, the ELAT still resulted in a high mortality rate (>70%) of American Shad. Therefore, to be able to study the migration behavior and dam passage survival of small and/or sensitive aquatic species such as juvenile American shad, an even smaller and lighter acoustic transmitter is required. Such a transmitter is disclosed herein that uses novel transducer and battery designs to reduce the size of the acoustic tracker while maintaining acoustic output levels.

The improvements in mortality results are accomplished by improved transducer design, electronic design, and battery design. These component-level design improvements are implemented in an overall tag design that enhances beam pattern uniformity and tag life. These improvements are discussed in more detail in the following sections.

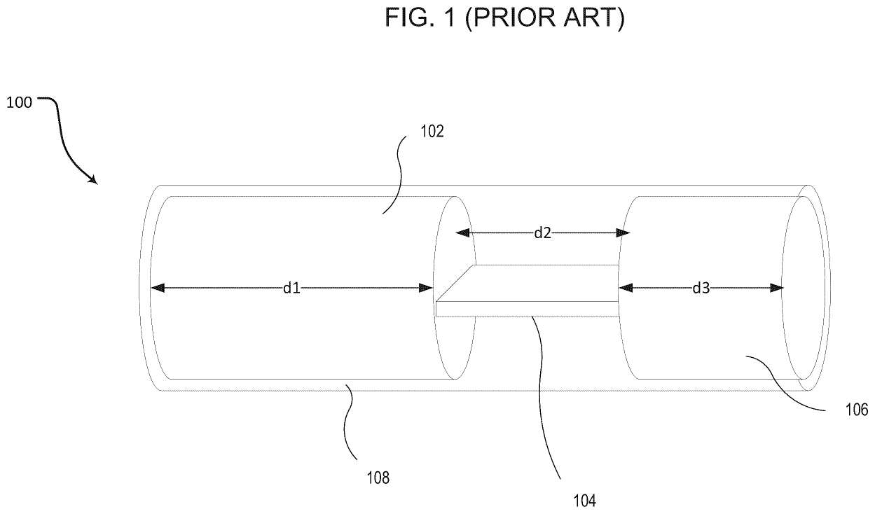

An acoustic fish tracker has three primary components that determine its size and shape. These conventional components are shown in FIG. 1, which depicts acoustic fish tracker 100. Specifically, a conventional acoustic fish tracker 100 will include some form of acoustic emitter 102, connected via electronic circuitry 104 to a battery or other power supply 106. The acoustic emitter 102, circuitry 104, and power supply 106 are housed within a housing 108 that keeps these components dry and safe from external interference. A typical form factor shape for an acoustic transmitter is, as shown in FIG. 1, substantially cylindrical.

Each of the components contributes partially to the length of the fish tracker 100. As shown in FIG. 1, acoustic emitter 102 has a dimension d1, electronic circuitry 104 has a dimension d2, and battery 106 has a dimension d3. The sum of these (d1+d2+d3) defines a minimum length of the fish tracker 100. In practice, the total length of the fish tracker 100 will often be slightly larger than this sum, to account for the thickness of the housing 108, and for tolerances within the housing 108. For example, the ELAT mentioned above is shaped substantially as a cylinder with a diameter of 2 mm and a length of 12 mm.

Improvements to conventional systems such as acoustic fish tracker 100 are described below. First, improvements to transducer design are discussed. Next, improvements to the electronics design are described. Next, improvements to the battery are disclosed. The final discussion of structural improvements herein relates to overall tag design and improvements thereto. Discussion of the functionality of the device, including beam pattern characteristics and tag life, are included afterwards.

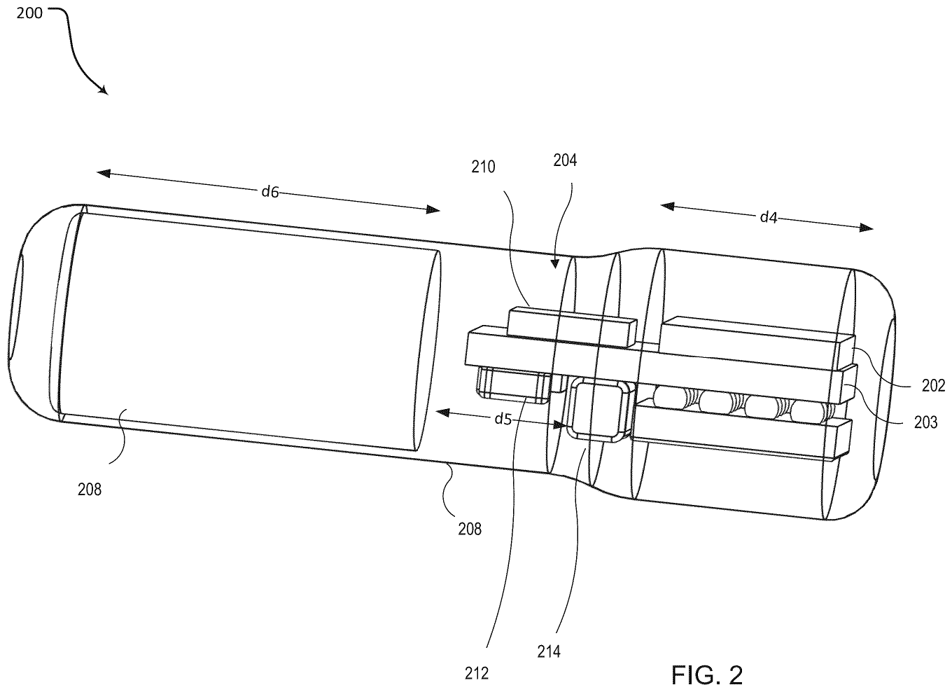

FIG. 2 is a transparent perspective view of an acoustic tracker 200 that shows these improved features in an assembled state. Acoustic tracker 200 includes an acoustic emitter 202, circuit board 203, electronic circuitry 204, and battery 208. The acoustic emitter 202 is powered by battery 208, and is controlled by a microcontroller 210. The microcontroller 210 has an internal clock, which can be calibrated against an external oscillator 212.

I. Transducer Design

The acoustic emitter 202 of FIG. 2 is a transducer that uses power from the battery 208 to generate acoustic signal that can be used for tracking.

For optimal acoustic performance and power efficiency, the size of the piezoelectric transducer of an acoustic emitter 202 can be selected such that it operates at a natural resonance frequency. The natural resonance frequency of a certain vibration mode (e.g., length, thickness and radial, etc.) of the acoustic emitter 202 is inversely proportional to the transducer's dimension in the vibration direction of interest. That is, smaller transducers result in higher resonance frequencies.

It is often desirable for new acoustic transmitters to retain the operation frequency of the older generations of transmitters, for compatibility with the existing detection hardware and infrastructure, unless operating in a different environment in which a different frequency has an advantage. In this way, the deployment cost of the new technology can be minimized. Currently, most acoustic fish tags use a Lead Zirconate Titanate (PZT) ceramic tube transducer operating in its hoop mode (i.e., resonates along the tube's radial direction) for a relatively uniform acoustic beam pattern. For the JSATS, which operate according to a standard set at 416.7 kHz+/−0.5%, a PZT tube with a diameter of ˜2.5 mm can be used to achieve a hoop-mode resonance at that frequency. In other embodiments where a different frequency is desired, differently configured transducers having different operating frequencies or resonant frequencies can be used.

The ELAT was also designed to operate at 417 kHz for compatibility, but the target diameter of the transmitter was only 2.0 mm, such that use of the hoop mode of a PZT tube was no longer viable. For the ELAT, then, a smaller PZT tube was used that resonates along its length direction rather than the radial direction.

To develop a new acoustic tracker 200 as shown in FIG. 2 that is even smaller than the ELAT while still maintaining a comparable acoustic performance and service life at the same operation frequency, the PZT tube transducer was replaced by smaller and lighter alternatives with superior piezoelectric properties.

Because of their highly ordered crystalline structures, ferroelectric single crystals such as those in the Pb(Mg1/3Nb2/3)O3-PbTiO3 (PMN-PT), Pb(Inl/2Nb1/2)O3-Pb(Mg1/3Nb2/3)O3-PbTiO3 (PIN-PMN-PT), and Pb(Znl/3Nb2/3)O3-PbTiO3 (PZN-PT) families, were selected as candidates because it was recognized that they possess piezoelectric charge constants several times that of the polycrystalline PZT ceramics. Also because of their highly ordered structures, piezoelectric properties of ferroelectric single crystals vary greatly along different crystallographic directions. This creates challenges for using them in acoustic fish tags, where a uniform acoustic beam pattern is desired. However, we have discovered in theoretical analysis of detection ranges that, if the acoustic signal strength variations in different directions can be limited within several decibels, the variations in the detection range of the tag in a realistic aquatic environment is only 20-30%, which is acceptable for fish tracking tags.

PZT ceramics are polycrystalline materials consisting of many micro single crystal grains whose polarization directions can be modified by an externally applied electric field. The directivity of the piezoelectric response of a PZT element can thus be readily tailored by manipulating its geometry (e.g., use of the tube geometry to achieve a uniform beam pattern). The piezoelectric response of a ferroelectric single crystal, however, is intrinsically highly directional throughout the material body, regardless of the geometry. Therefore, single crystal transducers are typically used in the form of flat plates that are cut based on specific crystallographic directions. The acoustic tracker 200 shown in FIG. 2 remains compatible with the JSATS—that is, emits at the same frequency as those devices—while using one or more polycrystalline acoustic emitters 202. For example, acoustic emitter 202 could be a Lead Magnesium Niobate-Lead Titanate (PMN-PT) plate or plates used as the transducer for emitting acoustic signals. Ferroelectric single crystal transducers have not historically been used in acoustic fish tags.

In one tested embodiment, a PMN-PT plate was used as the acoustic emitter 202 is the X2B PMN-PT variant produced by TRS Technologies (State College, Pennsylvania, USA). The plate is poled along the [011] direction of the crystal. The dimensions of the plate and their respective crystallographic directions are as follows: 1.75 mm in the [100] direction, 1.56 mm in the [011] direction and 0.257 mm in the [011] direction. It weighs merely 5 mg, only one fifth that of the PZT tube transducer in the ELAT. Notably, the dimensions of this embodiment are all significantly less than the 2 mm diameter of the ELAT. Thus the diameter of the acoustic tracker 200 along distance d4 can be substantially less than that of the ELAT along its corresponding portion associated with distance d1.

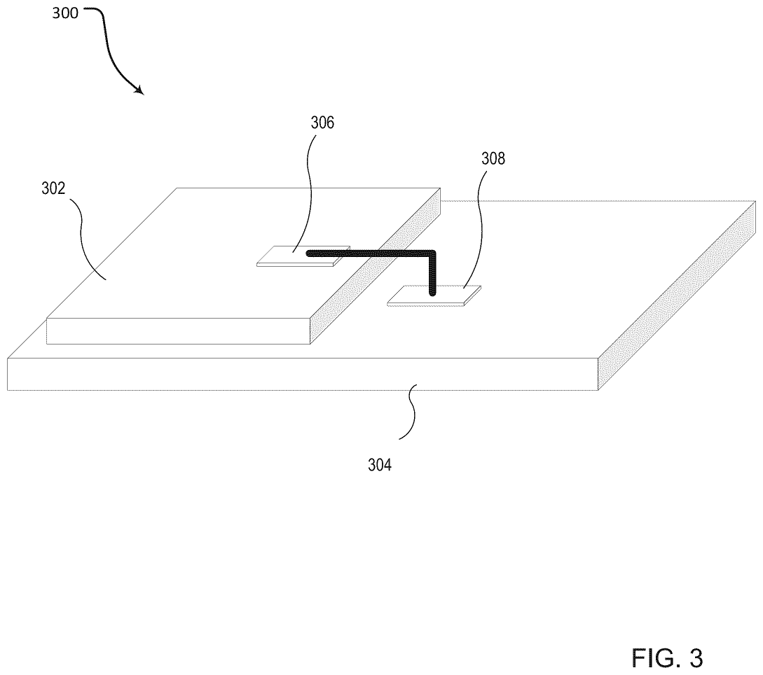

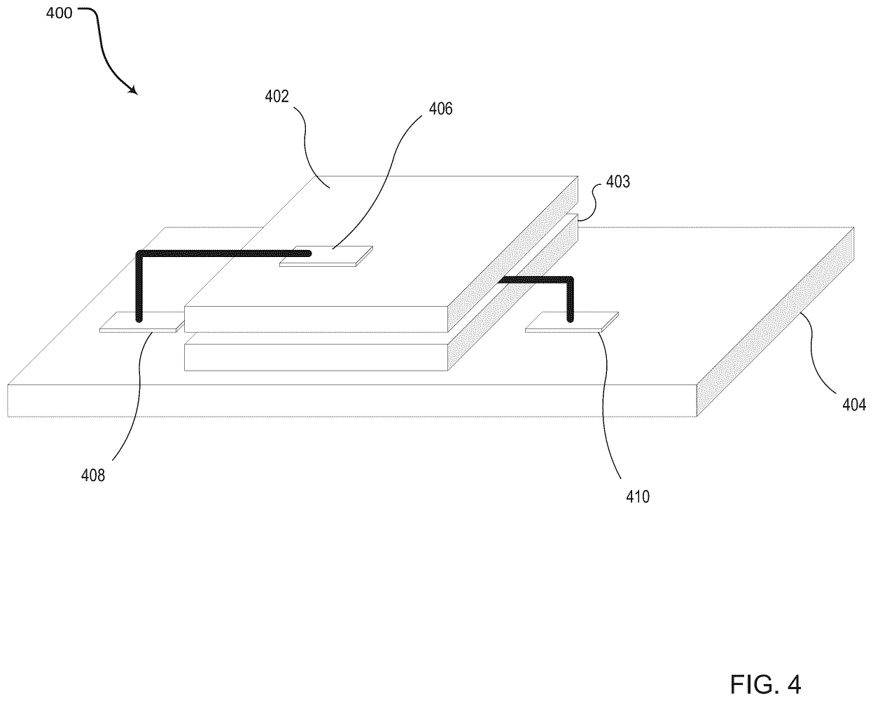

As shown in FIGS. 3 and 4, dependent upon the requirements for signal strength and tag life, either one or two ferroelectric single crystal plates, such as X2B plates, can be used in the acoustic tracker 200. These two versions of the acoustic tracker 200 will be referred to the “1-plate” and “2-plate” versions hereinafter. FIG. 3 shows a simplified diagram of the 1-plate version, while FIG. 4 shows a simplified diagram of the 2-plate version. It should be understood that there is no theoretical reason why more plates could not be used in other embodiments. Each additional plate would be arranged in an interleaved fashion with respect to poling direction, to ensure that the piezoelectrically-induced vibrations created by the plates combine in a constructive rather than destructive fashion.

FIG. 3 is a simplified diagram of a single-transducer acoustic emitter 300 according to an embodiment. The single-transducer acoustic emitter 300 of FIG. 3 includes a piezoelectric transducer 302 coupled to circuit board 304. The top side (with respect to the orientation shown in FIG. 3) is electrically connected as described above, so that alternating electrical current can be applied with electrodes on both the top and bottom sides of the piezoelectric transducer 302. An electrode connection pad 306 on the top side of the piezoelectric transducer 302 can be electrically connected to a corresponding electrode connection pad 308 of the circuit board 304. Circuit board 304 can then deliver alternating current to both sides of the piezoelectric transducer 302. The specific wiring of the circuitry within circuit board 304 is not shown, but it should be understood that charge of opposite polarity can be delivered to the top and bottom sides of the piezoelectric transducer 302.

The 2-plate acoustic emitter 400 shown in FIG. 4 uses a stack of two identical X2B plates to enhance the signal strength (by ˜2 to 3 dB), at the expense of the tag battery life. The plate transducers 402 and 403 are placed flat on the circuit board 404 and connected to the circuit using silver-filled epoxy or other appropriate electrical and mechanical connection, depicted as pads 406, 408, and 410. In alternative embodiments, non-identical single crystal ferroelectric plates could be used, and in those embodiments different sizes, shapes, and materials may be used to make the resonant frequencies of the plates similar or identical so that they constructively interfere in-phase when operated.

In the 1-plate version shown in FIG. 3, the poling direction of the plate can be oriented either up or down. However, in the 2-plate version shown in FIG. 4, the two transducers 402 and 403 are stacked together and are connected to the circuit board 404 in an antiparallel fashion. In other words, the poling directions of the two transducers 402 and 403 are oppositely oriented. This arrangement ensures that the mechanical or acoustic outputs of the two plates are in phase to enhance the overall signal strength.

Electronic Design

To reduce the footprint of the electronic circuit of the shad tag, the smallest commercially available components that are consistent with the overall design requirements were selected.

First, the electronic design incorporates an oscillator. The oscillator is shown in FIG. 2 with reference number 212. Regarding the oscillator 212 (FIG. 2), as described above the conventional frequency used in aquatic tracking tags is about 417 kHz (ELAT is set at 416.7-kHz modulation frequency). In one embodiment, this frequency can be generated by calibrating the internal clock of the microcontroller (210, see FIG. 2) to an external 256 Hz oscillator Y1 (SiT1534) used as oscillator 212. The internal clock of the microcontroller 210 can be calibrated occasionally, such as every 250 transmissions. Instead of generating the modulation frequency with the calibration method, use of a dedicated oscillator 212 clock for modulation frequency can significantly increase the frequency stability.

The oscillator 212 has a footprint of 1.0 by 0.8 mm and has a startup time of 2 ms. The extra energy consumption added to each transmission for the oscillator 212 is estimated to be less than 6 μJ, which is an acceptable energy consumption overhead and much smaller compared to other oscillators of similar sizes on the market. Acceptable energy consumption is based upon battery capacity and expected lifetime use.

A second important feature of the relates to the capacitor, shown with respect to reference number 214 in FIG. 2.

Capacitor 214 can be a 15-μF Tantalum capacitor in one embodiment. Such a capacitor is small (about 1 mm×0.5 mm) in commercially-available forms. The capacitor 214 is substantially smaller than those used in conventional devices. In the ELAT, for example, three 10 uF Tantalum capacitors (1.0 mm×0.5 mm) are used to store the energy required for each transmission. The switch of the piezoelectric transducer type from PZT to single crystal reduces the energy consumption of each transmission, making this level of energy storage unnecessary.

The hardware design and layout of the circuit design of the acoustic tracker 200 uses advanced layout techniques such as Via-in-Pad technique. Some other modifications to conventional electronic design were also made to the hardware that are enabled by the lower power usage and smaller size. For instance, the pins of the microcontroller used to drive the acoustic emitter 202 and oscillator 212 can be selected to minimize size, and to further shorten the length of the circuit board 203, the ground/negative pad for the microbattery 208 can be removed. The negative wire of the microbattery 208 can be connected to the ground side of the 15-μF Tantalum capacitor. These layout changes along with the oscillator and capacitor changes described above achieved a circuit board length of only 3.3 mm, which is about half that of the smallest existing device (the ELAT).

Battery Design

The sizes of conventionally available battery components present a major challenge for miniaturization of battery-powered micro-sensors and transmitters. Conventionally, batteries have been designed for acoustic trackers as described in Applicant's earlier-filed application serial number U.S. Ser. No. 16/697,936, the contents of which are incorporated herein by reference in their entirety.

As described in this section, a piezoelectric ceramic tube transducer and a microbattery can also be combined into a single component, to further downsize the overall acoustic tracker (e.g., acoustic tracker 200). In testing, this design improved both size and battery capacity. Although the battery capacity of the hybrid was about 30% smaller than that of the discrete micro-battery in the reference transmitter because of the smaller volume available in the tube transducer than in the battery case, compared to the combination of the discrete micro-battery and piezoelectric transducer in the reference transmitter, the hybrid design reduced the volume and weight by 41% and 19%, respectively. Integration of the battery components into the transducer did not significantly affect the acoustic transmission performance of the transducer. Thus, incorporating the piezoelectric ceramic tube transducer and the microbattery into a unitary element can be a viable approach for pushing the miniaturization envelope of battery-powered acoustic micro-transmitters. This approach is also applicable to the design of other micro-sensors.

Most miniaturized commercial aquatic trackers and tags use silver oxide button-cell batteries because of their compact sizes. Compared to lithium batteries, these batteries are relatively heavy and are less energy dense. Conventionally-used batteries for acoustic trackers, for example, are cylindrical and share the same outer diameter of 1.8 mm, which is 0.2 mm smaller than the diameter of the ELAT and permits the use of a 0.1-mm thick epoxy encapsulation (108, FIG. 1) to result in an overall diameter of 2 mm. Together, the microbattery 106 and the acoustic emitter 102 (FIG. 1) contribute about two-thirds of the volume of a conventional acoustic tracker 100. Therefore, it was recognized that if the PZT tube transducer can double as the housing for the battery components in addition to emitting acoustic signals, the overall length and volume of the acoustic tracker would be significantly reduced.

The shad tag described herein uses a microbattery (e.g., microbattery 208 of FIG. 2). In one embodiment, the microbattery 208 uses a cylindrical micro-battery which is 1.8 mm in diameter and 3.2 mm in length. The battery leverages a new micro-battery technologies developed at PNNL which directly presses the battery material powder into the cylindrical battery housing instead of the traditional jellyroll cell design for cylindrical batteries. This new design uses a drilled column in the center of the cell.

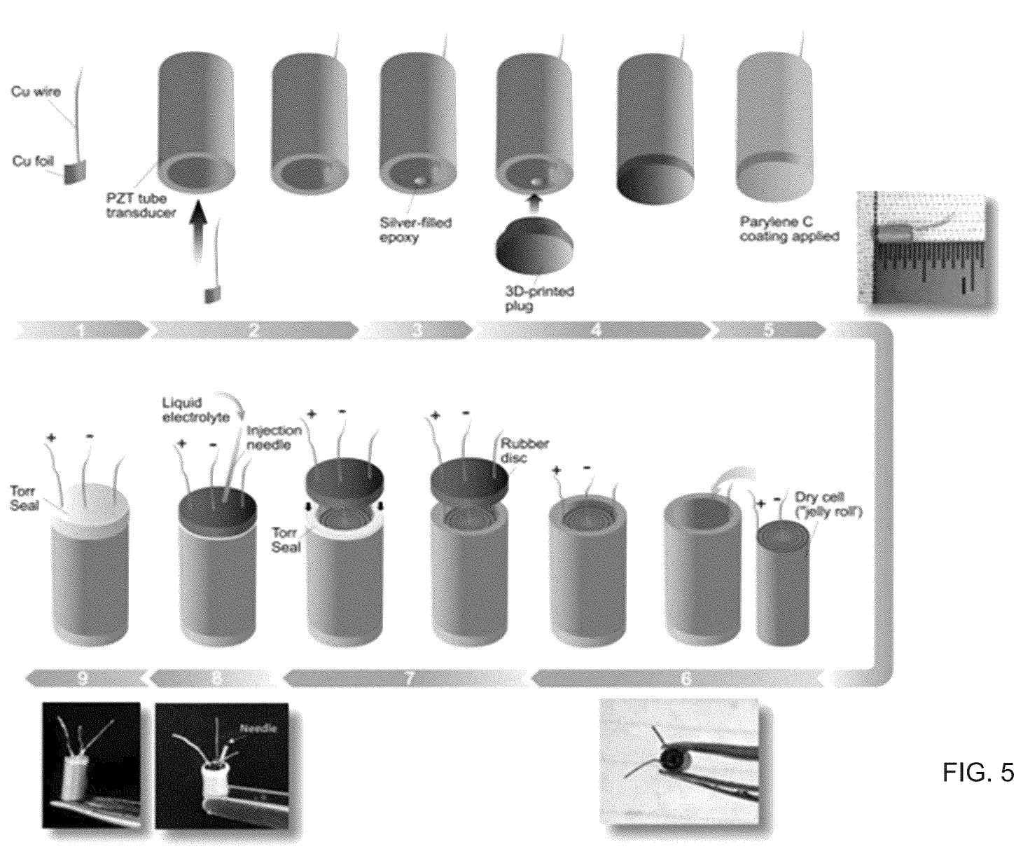

FIG. 5 shows an alternative assembly of a microbattery to the version described above. To house the battery cell inside and still function as a transducer for acoustic transmission, the PZT tube transducer should meet two criteria. First, once the battery materials are placed inside, the microbattery may be completely closed off and obtain a hermetic seal to prevent air and humidity exposure to the lithium metal. Second, in addition to the two battery wires which must exit the battery to provide a voltage output, a third wire is needed to be connected to the inner electrode of the PZT for the circuit to apply voltage signals across the PZT tube's wall thickness direction.

To convert the PZT tube into a container, a plug is glued to one end of the tube to form a “vase” structure. This plug-and-vase construction is shown in the method depicted in FIG. 5.

The wire required for applying a voltage to the inner electrode of the PZT is attached to the inside of the PZT via a copper foil and silver-filled epoxy. Before loading the battery materials into the tube, a 25-μm thick waterproof polymer (Parylene-C) coating is applied to the entire structure to form an inert barrier between the PZT ceramic and the liquid electrolyte of the battery. This coating also provides additional structural support for the 3D-printed plug as well as the silver bond between the copper foil and the inner electrode of the tube.

As shown the upper-left of FIG. 5, a piece of copper foil is attached to a thin copper wire. The wire can be soldered to the foil, for example. Copper is one viable material, but it should be understood that other materials could be used, especially ones that are both lightweight and ductile.

Next, as indicated by the numeral 2, the foil and wire are inserted into the PZT tube: The free end of the wire is fed through the PZT tube and the foil is positioned at the end of the tube opposite to the end where the wire exits, so it would not get in the way of loading the battery materials later.

Next, as indicated by the numeral 3, the foil is adhered to the inner electrode of the PZT tube. In one embodiment, the adherent could be a silver-filled epoxy, which is both good adhesive and also conductive.

Next, as indicated by the numeral 4, the end of the PZT tube where the foil is located is closed with the plug. In one embodiment, the plug is 3D printed to have specific dimensions appropriate for the PZT tube. A thin 3D-printed plug with a lip is used to close off the end of the PZT tube where the foil is located. A small amount of insulating epoxy is applied around the lip of the plug before pushing the plug into the tube.

Next, as indicated by the numeral 5, a coating is applied over the plug. For example, a 25-μm thick Parylene-C layer can be applied to the entire PZT tube through a vapor deposition process. After applying the coating at 5, the hybrid battery case is ready for battery assembly.

Next, as indicated by the numeral 6, the battery dry cell is placed into the PZT tube: The battery can, for example, use a “jelly-roll” styled Li/CFx dry cell formed by rolling laminated thin sheets of lithium metal and CFx, both of which are individually wrapped by a layer of micro-porous polypropylene separator (Celgard 2500, Celgard LLC, USA). The dry cell can be placed into the PZT tube with the cathode and anode wires extending outside the tube as shown at 6.

Next, as shown at 7, a closure disk can be adhered to close the PZT tube. For example, a rubber disk can be used as the closure disk, and can be used as a cap to close the hybrid case. A needle (0.45 mm in diameter) or other mechanism can be used to create holes in the rubber disk for the three wires to pass through. After the wires are threaded through the rubber disk, the epoxy can be applied on the lip of the PZT tube to glue the closure disk onto the tube.

Next, as shown at 8, liquid electrolyte can be injected into the battery. An injection needle (0.35 mm in diameter) can be used to puncture the closure disk. With the needle still inserted in the disk, the entire PZT tube can be soaked in a bath of the liquid electrolyte (such as 1M lithium bis[trifluoromethanesulfonyl]imide in propylene carbonate/dimethoxyethane [volume ratio 1:1]; Gotion, Inc). Partial vacuum can then be applied to promote wetting of the electrode assembly by the liquid electrolyte. The entire cell assembly can then be rinsed, such as by dimethoxyethane, and wiped clean to remove any liquid electrolyte residue on the PZT tube.

Next, as shown at 9, the battery can be sealed. A thin layer (<0.5 mm) of sealant, such as Torr Seal, can be applied over the closure disk to form a hermetic seal for the battery construct.

A battery made according to the method of FIG. 5 has been created and tested for impedance and capacity. For the hybrid prototype to function as an acoustic transducer, a thin copper wire was attached to the external electrode of the PZT tube (i.e., the outer wall surface of the tube) using a small amount of silver-filled epoxy, so a driving voltage could be applied across the wall thickness direction of the transducer. The acoustic transmission function of the hybrid prototypes was verified in air and the source level and acoustic beam pattern of a prototype was also measured underwater.

The characterization of the underwater acoustic performance (i.e., the source level and beam pattern) of the hybrid prototype was carried out in an acoustic tank. The main purpose of these tests was to evaluate if the battery cell inside the PZT tube resulted in any significant degradation of the acoustic performance of the transducer, compared to the regular PZT tube transducer used in conventional devices such as the ELAT. The prototype had a 3D-printed plug, which was pointed directly at the hydrophone as its starting point for the beam pattern measurement (i.e., the 0° position). During the beam pattern measurement, the prototype was transmitting acoustic signals at a pulse rate interval of 1 second. The motion control unit rotated the prototype about the vertical axis of the tank in a full circle, at a 10-degree interval and staying at each position for 10 seconds. The average value of the source level measured at each angle of the frontal 180° (i.e., 270°-0° and 0°-90°) was taken as the representative result of the prototype's source level.

The abilities of the hybrid prototype functioning as a battery and an acoustic transducer were demonstrated by using the prototype as both the power source and the acoustic transducer. The acoustic transmissions emitted by the hybrid's PZT shell were detected through physical contact (in air) with another PZT tube (“the detector”).

After activating the circuit, by gently touching the outer wall surface of the prototype with the detector transducer and maintaining the contact, we successfully detected and decoded the acoustic signals emitted by the PZT shell of the hybrid prototype. This demonstrated the ability of the hybrid to serve as the power source and the acoustic transducer simultaneously in a miniaturized acoustic transmitter.

To maximize the transducer's acoustic performance, its dimensions were purposely chosen to obtain a natural resonance near 417 kHz, as described above, because this will be backwards-compatible with detectors designed for the JSATS' operation frequency, along its length direction.

During operation, although the transducer is driven across its wall thickness direction, vibration is occurring both in its length and radial directions, with the amplitude along the length direction being higher due to the resonance. The vibration in the tube's radial direction emits acoustic energy both outward and inward. As only the sound waves propagating outward can be detected by the hydrophones, it is desired that more of the emitted acoustic energy in the radial direction be directed outward to maximize the detection probability of the acoustic signal. An effective way to achieve this is to have a large acoustic impedance mismatch at the interface between the inner wall of the tube and the substance that fills the inside of the tube, so the power transmission coefficient at this interface can be minimized. In other words, it is preferred that the inside of the PZT tube is filled with air for maximum acoustic impedance mismatch, since the acoustic impedance of air is very low due to its ultralow density. In the hybrid design, in lieu of air and circuit components, the space inside the tube is filled with the battery dry cell and the liquid electrolyte. Because of these materials and higher sound velocities in them, this results in a smaller acoustic impedance mismatch at the PZT tube's inner wall surface, compared to devices using air.

Nonetheless, the device according to the method of FIG. 5 exhibited a more uniform beam pattern than the PZT transducer in conventional devices such as the ELAT. When the axis of the transducer was pointed at the hydrophone (i.e., the zero-degree position in the beam pattern plot), it showed a source level of ˜151 dB re 1 μPa @ 1 m, about 1-2 dB higher than that of the ELAT. Such a difference was within the variation we typically observed between two identical PZT tubes and is usually caused by the manufacturing tolerance of the PZT tube as well as the tolerances in the components of the driving circuit.

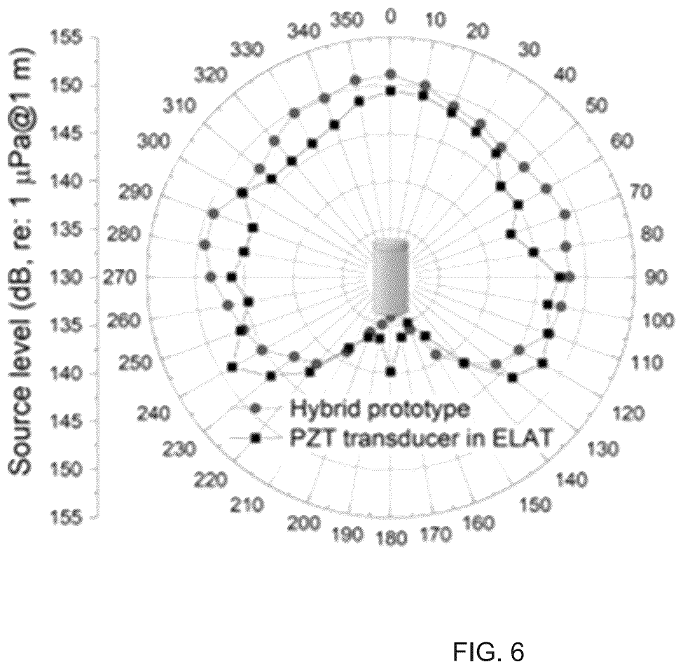

As the transducer rotated away from the hydrophone, the hybrid showed a high source level, higher than the conventional (ELAT) device by 1-5 dB, dependent upon the angle. In other words, the ELAT possesses a slightly narrower beam pattern in the frontal 180°, where the results are typically used to obtain the average source level as the representative source level of the transmitter, because the sound wave emitted toward the rear 180° directions is usually blocked by the circuit board and the battery. The overall slightly more directional beam pattern (and hence slightly weaker average source level) of the ELAT may have been a result of the close proximity (<1 mm) of a circuit component (the microcontroller) directly behind the PZT transducer in the ELAT. As previously shown, in a miniaturized acoustic transmitter, the close proximity between the PZT transducer and the circuit components directly behind it may distort the beam pattern of the transducer and result in a lower source level when it turns away from the hydrophone. In the case of the device made according to the method depicted in FIG. 5, during these acoustic measurements, because the sample was a stand-alone PZT tube with no circuit components positioned close by, its beam pattern was not subjected to such distortion. Therefore, it can be concluded that compared to the PZT tube transducer in the ELAT, the presence of the battery components inside the PZT tube does not have a significant impact on the source level of the transducer. FIG. 6 shows a comparison between the device described herein with the PZT ceramic tube transducer used as the battery housing as described in FIG. 5 shown as the “hybrid prototype” and compared to the ELAT transducer.

Beam Patterns and Tag Life

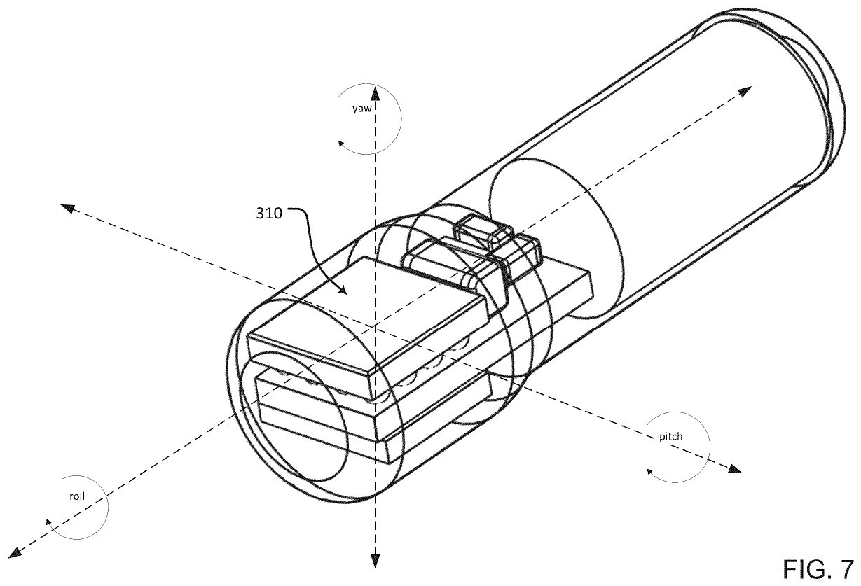

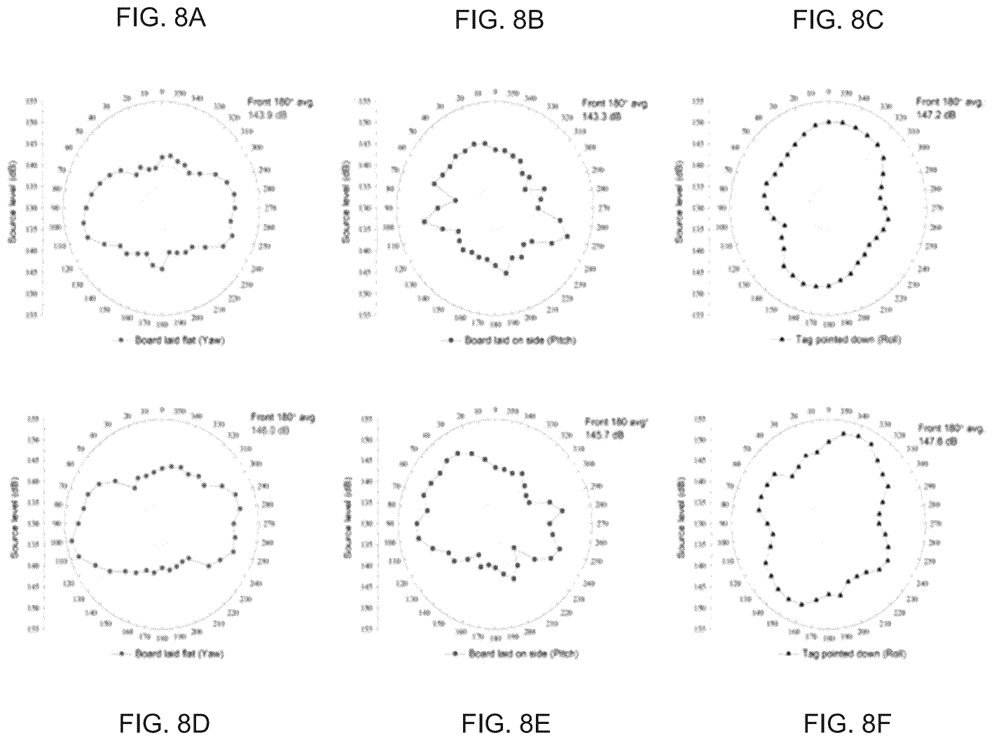

Returning now to a discussion of the 1-plate and 2-plate designs, FIG. 7 shows a reference frame that is used throughout the discussion of FIGS. 8A-8F.

For performance evaluation, prototypes of the 1-plate and 2-plate versions of the acoustic tracker 200 were fabricated using the manufacturing protocols described above and tested for both the acoustic beam pattern and tag life. The beam patterns of the prototypes were measured in three rotational axes: vertical, lateral and longitudinal (i.e., yaw, pitch and roll, respectively. FIG. 7 shows these three axes.

Both 1-plate and 2-plate versions showed similarly shaped beam patterns in the same tag orientations (FIGS. 8A-8F). For each design, the frontal 180° average source levels about the yaw and pitch axes are quite similar. The average frontal 180° source level of the 1-plate prototypes about the yaw and pitch axes is ˜144 dB, and that of the 2-plate prototypes showed a 2-dB enhancement, at ˜146 dB. About the roll axis, both designs showed frontal 180° average source levels of both designs are quite similar, both at ˜147 dB. Beam patterns of the 1-plate and 2-plate acoustic tracker 200 prototypes about three different rotational axes: 1-plate (yaw) is shown in FIG. 8A; 1-plate (pitch) is shown in FIG. 8B; 1-plate (roll) is shown in FIG. 8C; 2-plate (yaw) is shown in FIG. 8D; 2-plate (pitch) is shown in FIG. 8E; and 2-plate (roll) is shown in FIG. 8F.

Furthermore, the lifespan of the devices was compared to conventional devices, such as the ELAT. Overall, the 1-plate and 2-plate design is significantly smaller in the length direction, and in weight, while having comparable other characteristics. The third design (with battery in the PZT tube, as described above) also compares favorably to the ELAT, as discussed in the preceding section.

| | 1-plate | 2-plate | |
|---|---|---|---|
| | shad tag | shad tag | ELAT |
| Diameter (mm) | 2.0-2.3 | 2.0-2.3 | 2.0 |
| Length (mm) | 7.6 | 7.6 | 12.0 |
| Weight in air (mg) | 50 | 57 | 84 |
| Operation frequency (kHz) | 416.7 | 416.7 | 416.7 |
| Source level (dB, ref: 1 | 144 | 146 | 147 |
| μPa@1 m) | | | |
| Tag life (days, @5-second PRI) | 28 | 20 | 26 |

Having described the preferred aspects and implementations of the present disclosure, modifications and equivalents of the disclosed concepts may readily occur to one skilled in the art. However, it is intended that such modifications and equivalents be included within the scope of the claims which are appended hereto.

Various advantages and novel features of the present disclosure are described herein and will become further readily apparent to those skilled in this art from the following detailed description. In the preceding and following descriptions the preferred embodiment of the disclosure have been shown and described by way of illustration of the best mode contemplated for carrying out the disclosure. As will be realized, the disclosure is capable of modification in various respects without departing from the disclosure. Accordingly, the drawings and description of the preferred embodiment set forth hereafter are to be regarded as illustrative in nature, and not as restrictive.

What is claimed is:

1. An acoustic tracking device comprising:
an acoustic transducer comprising a ferroelectric single crystal piezoelectric component;
a microprocessor electronically coupled to the acoustic transducer to drive the acoustic transducer;
an oscillator having a preset operating frequency, the oscillator electronically coupled to the microprocessor; and
a battery electronically coupled to each of the microprocessor and the oscillator.

2. The acoustic tracking device of claim 1, wherein the acoustic transducer comprises a plurality of ferroelectric single crystal piezoelectric components arranged in a stack, wherein the polling direction of a first one of the plurality of ferroelectric single crystal piezoelectric components is oriented opposite of the polling direction of an adjacent one of the ferroelectric single crystal piezoelectric components of the stack.

3. The acoustic tracking device of claim 1, wherein the ferroelectric single crystal piezoelectric component is shaped as a tube.

4. The acoustic tracking device of claim 3, wherein the battery is arranged within the tube formed by the ferroelectric single crystal piezoelectric.

5. The acoustic tracking device of claim 1, wherein the preset operating frequency is 417 kHz.

6. The acoustic tracking device of claim 5, wherein a natural resonance frequency of the acoustic transducer is 417 kHz.

7. The acoustic tracking device of claim 1, wherein the microprocessor is configured to drive the acoustic transducer at the preset frequency.

8. The acoustic tracking device of claim 7, wherein the microprocessor is configured to calibrate a driving frequency of the acoustic transducer based upon a signal from the oscillator at the preset frequency.

9. The acoustic tracking device of claim 1, further comprising a housing configured to hold the acoustic transducer, the microprocessor, the oscillator, and the battery within a form factor.

10. The acoustic tracking device of claim 9, wherein the form factor is substantially cylindrical, with a diameter of 2 mm or less and a length of 8 mm or less.

11. The acoustic tracking device of claim 10, wherein the acoustic tracking device has a weight of 57 mg or less.

12. An acoustic tracking device comprising:
an acoustic transducer shaped substantially as a tube open at one end;
a microprocessor electronically coupled to the acoustic transducer to drive the acoustic transducer;
a battery arranged within the tube; and
a cap arranged in the tube at the open end to hermetically seal the battery within the tube and the cap.

13. The acoustic tracking device of claim 13, further comprising a waterproof coating applied around the tube and the cap.

14. The acoustic tracking device of claim 12, wherein the tube comprises a ferroelectric single crystal piezoelectric with a hole drilled partially through it along the polling direction of the ferroelectric single crystal piezoelectric.

15. The acoustic tracking device of claim 12, wherein a natural resonance frequency of the acoustic transducer is 417 kHz.

16. The acoustic tracking device of claim 15, wherein the microprocessor is configured to drive the acoustic transducer at a driving frequency of 417 kHz.

17. The acoustic tracking device of claim 16, wherein the microprocessor is configured to calibrate the driving frequency of the acoustic transducer based upon a signal from an oscillator.

18. A method of forming a battery-transducer hybrid, the method comprising:
connecting a wire to a foil element;
inserting the foil and wire element into a piezoelectric tube;
adhering the foil element to an inner electrode at one end of the piezoelectric tube;
closing the one end of the piezoelectric tube at which the foil is adhered;
applying a coating to the one end to seal the one end;
placing a battery dry cell into the piezoelectric tube through a second end opposite the one end;
adhering a closure disk to the second end;
injecting an electrolyte into the center of the piezoelectric tube; and
sealing the tube to the closure disk.

19. The method of claim 18, wherein the piezoelectric tube has a resonant frequency of 417 kHz.

20. A battery-transducer hybrid formed according to the method of claim 18.
